(19) United States
(12) Patent Application Publication
(10) Pub. No.: US 2015/0019299 A1
(43) Pub. Date: Jan. 15, 2015

(54) Method of Generating Golf Index Reports

(71) Applicant: Joseph Harvey, Rio Grande, PR (US)

(72) Inventor: Joseph Harvey, Rio Grande, PR (US)

(21) Appl. No.: 14/330,399

(22) Filed: Jul. 14, 2014

Related U.S. Application Data
(60) Provisional application No. 61/845,863, filed on Jul. 12, 2013.

(51) Int. Cl. G06Q 10/06

(52) U.S. Cl. CPC G06Q 10/0639
USPC 705/7.38

(57) ABSTRACT

A method of generating a golf index report provides users with a means of assessing the performance of their golf course against other similar golf courses. The method accomplishes this through a golf index reporting system that negotiates financial and usage information collected from a group collaborating accounts utilizing the information to calculate average values for the group. The average values for the group are compared to an individual account's financial and usage information generating a personalized index report. The personalized index report anonymizes the financial and usage information for individual group members and provides a more complete representation of the marketplace.

The current application claims a priority to the U.S. Provisional Patent application Ser. No. 61/845,863 filed on Jul. 12, 2013. The current application is filed on Jul. 14, 2014 while Jul. 12, 2014 was on a weekend.

### FIELD OF THE INVENTION

The present invention relates generally to a method of reporting and comparing golf course performance. More specifically the present invention is a method of reporting and comparing the financial performance between golf courses and groups of golf courses.

### BACKGROUND OF THE INVENTION

Effective golf course utilization and staffing are key aspects that help ensure profitability for a golf course. Through modifications in staffing, strategic partnerships, and promotions, managing elements of a golf course can improve utilization of the golf course increasing revenue. One of the difficulties in implementing modifications is determining the effectiveness of particular modification. Due to weather and marketplace conditions, golf course utilization can greatly vary from one month to another. This variability makes it difficult to determine the effectiveness of a particular modification.

It is therefore the object of the present invention to provide a method of generating a golf index report provides users with a means of assessing the performance of their golf course against other similar golf courses. The method accomplishes this through a golf index reporting system that negotiates financial and usage information collected from a group collaborating accounts utilizing the information to calculate average values for the group. The average values for the group are compared to an individual account's financial and usage information generating a personalized index report. The personalized index report anonymizes the financial and usage information for individual group members and provides a more complete representation of the marketplace.

### BRIEF DESCRIPTIONS OF THE DRAWINGS

FIG. 1 is a flow chart displaying the general process overview of the method of generating a golf index report.

FIG. 2 is a flow chart displaying the step of creating a new user account as per the current embodiment of the present invention.

FIG. 3 is a flow chart displaying the step of creating a competitive set as per the current embodiment of the present invention.

FIG. 4 is a block diagram displaying the values found in the usage statistics submitted in with the account data.

FIG. 5 is a block diagram displaying the values found in the revenue statistics submitted with the account data.

FIG. 6 is a flow chart diagram displaying the steps involved in calculating the values of the account statistics.

FIG. 7 is a flow chart diagram displaying the steps involved in calculating competitive set statistic.

FIG. 8 is a flow chart diagram displaying the steps involved in generating the index report for a particular reporting period.

### DETAIL DESCRIPTIONS OF THE INVENTION

All illustrations of the drawings are for the purpose of describing selected versions of the present invention and are not intended to limit the scope of the present invention.

The present invention is a golf index reporting system that provides users with a means of assessing the performance of their golf course against other similar golf courses. The present invention accomplishes this by negotiating financial and usage information collected from a group collaborating accounts utilizing the information to calculate average values for the group. The average values for the group are compared to an individual account's financial and usage information generating a personalized index report. The personalized index report anonymizes the financial and usage information for individual group members and provides a more complete representation of the marketplace.

In the current embodiment of the present invention, the method of generating a golf index report is provided with a golf index reporting system. The golf index reporting system is a computerized system with capabilities allowing it to identify particular interaction, receive and store information, make calculations, and send information to particular destinations. It should be noted that capabilities of the golf index reporting system can be accomplished through a plurality of means found in, but not necessarily limiting to, existing computerized systems.

In the current embodiment of the present invention, the golf index reporting system comprises a user base. The user base functions as a repository for a plurality of user accounts. The user base facilitates data handling and storage needs for information associated with the plurality of user accounts. The plurality of user accounts are active participants of the golf index reporting system that submit account data each reporting period. Each user account of the plurality of user accounts carries an association with a particular golf course allowing of the received account data to be representative of a particular golf course in the system.

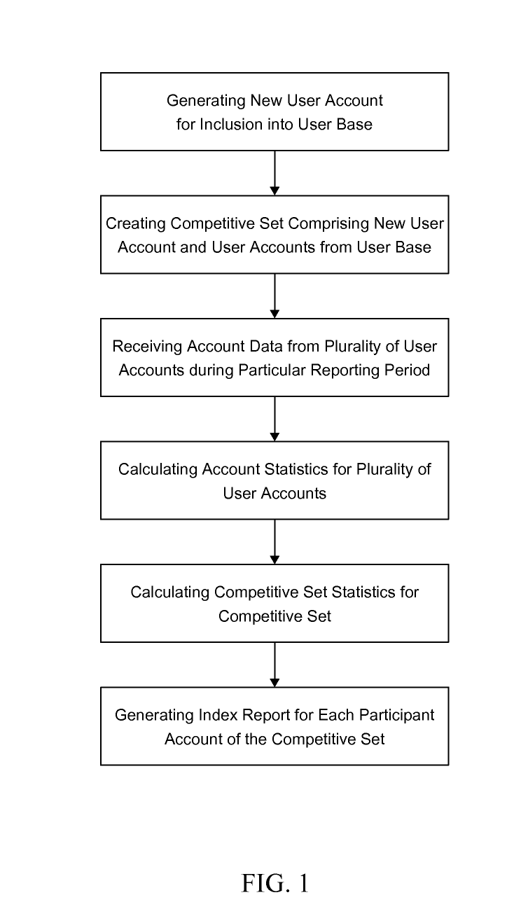

Referencing FIG. 1, in the current embodiment of the present invention, the method of generating a golf index report comprises the steps of generating a new user account for inclusion into a user base, creating a competitive set comprising the new user account and user accounts from the user base, receiving account data from a plurality of user accounts during a particular reporting period, calculating account statistics for the plurality of user accounts, calculating competitive set statistics for the competitive set, and generating an index report for each participant account of the competitive set.

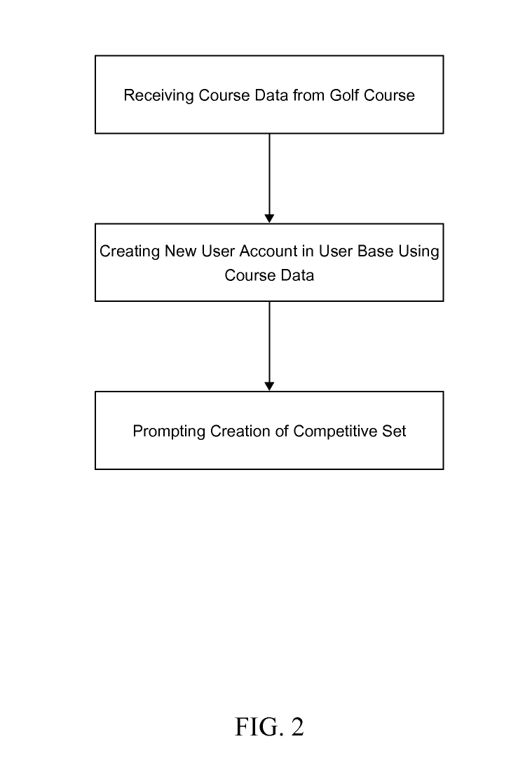

Referencing FIG. 2, the step of generating a new user account for inclusion into the user base is provided as a means of populating the user base with active participants. The process for generating a new user account comprises the steps of receiving course data from a golf course and creating a new user account in the user base using the course data. It should be noted that in an alternative embodiment, the system can receive a request to create a new user account and then prompt for submission of the course data.

Referencing FIG. 2, the step of receiving the course data from a golf course is the initiation step in the creation process, as the course data contains unique information to a particular golf course. Course data comprises a golf course identifier and the number of holes offered by the golf course. The golf course identifier is the name by which a particular golf course is currently known by and is used to register the golf course to the new user account. The number of holes offered by the golf course is information that is used to golf course utilization values. It should be noted that the course data can additionally include detailed information such as location information.

Referencing FIG. 2, the step of creating the new user account in the user base occurs after receiving the golf course identifier. The golf course identifier is utilized as the means of differentiating a user account within the user base. Upon creating the new user account, the number of holes offered by the golf course, and any remaining information received in the course data is associated with the new user account. The creation of the new user account within the user base, prompts creation of a competitive set for the new user account. The prompt for creating a competitive set is a necessary step in the creation of the new user account as the functionality offered by the golf index reporting system is not utilized until a user account becomes a participating member of a competitive set. It should be noted that the prompt for creating a competitive set serves as a user notification but functions as a hold for the new user account until the competitive set creation process is initiated.

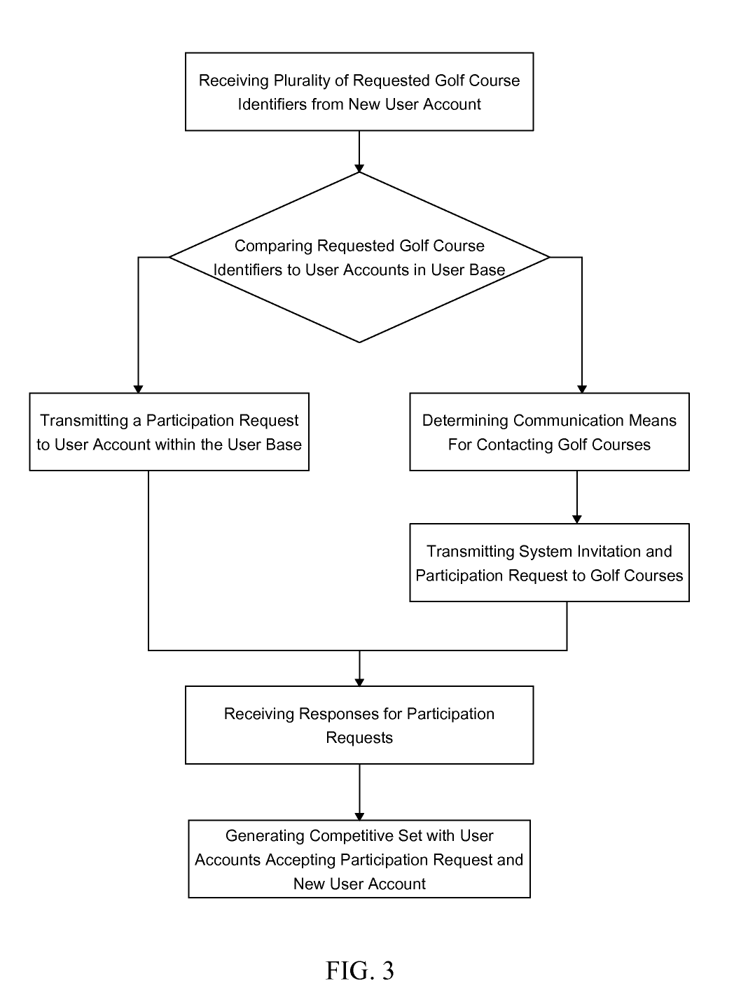

Referencing FIG. 3, the step of creating a competitive set for the new user account allows the new user account to request golf courses that would provide a more complete representation of the marketplace in the index report. The process of creating the competitive set for the new user account comprises the steps of receiving a plurality of requested golf course identifiers from the new user account, transmitting participation request to the particular golf courses associated with the requested golf course identifiers, receiving responses for the participation requests, and generating a competitive set with the user accounts accepting the participation request.

Referencing FIG. 3, the plurality of requested golf course identifiers are submitted by the new user account to the system following the prompt to create a competitive set. Each requested golf course identifier of the plurality of requested golf course identifiers is associated with a particular golf course. it should be noted that a requested golf course identifiers don not require the associated particular golf course to have an established association with a user account within the user base. upon receiving the plurality of requested golf course identifiers, the system initiates a process to determine a means of communicating the a participation request each particular golf course associated with a requested golf course identifier. It should be noted that a competitive set is a collaboration and as such allows participation to be at the discretion of each particular golf course. After the transmission of the participation requests, the system receives a response. The system determines whether each response is an acceptance or rejection to the participation request. It should be noted that while a rejection response can originate from a golf course associated with a user account in the user base, as well as an unregistered golf course, an acceptance response can only originate from user accounts in the user base. Upon determining the accepting user accounts, the system generates a competitive set for the accepting user accounts and the new user account.

Referencing FIG. 3, the step of transmitting participation requests to particular golf courses associated with the requested golf course identifiers is preceded by a step that determines the manner through which the participation request would be sent. The determination is based on the presence of user accounts within the user base that match the requested golf course identifiers. As a result the step is a comparison step that seeks to find user accounts within the user base that matches the requested golf course identifier. If the golf course identifier of a user account in the user base matches the requested golf course identifier, then the participation request is transmitted to directly to the user account. If a golf course identifier of the plurality of user accounts in the user base does not match the particular requested golf course identifier, then a determination is made to identify a communications means for contacting the particular golf course associated with the requested golf course identifier. It should be noted that the communications means for contacting the particular golf course not associated with a user account could be accomplished by any viable communications. Following the determination of a communications means for contacting the particular golf course, the system transmits a system invitation and a participation request. The system invitation is sent with the participation request as acceptance of the participation request requires the particular golf course to be associated with a user account within the user base.

the step of receiving account data from the plurality of user accounts is provided as the means of collecting information from each user account in the user base in order to calculate account statistics for. The account data received from each user account is derived for a particular reporting period. Account data contains information regarding the usage and the revenue of a golf course associated with the user account, during a particular reporting period. The reporting period is an interval of time during which the account data is collected for. It should be noted that the interval of time corresponding to the reporting period can be measured on an hourly, daily, weekly, or monthly basis. Furthermore, it should be noted that account data could be directly provided through a submission form or through a Point of sale terminal that transmits transaction information. In the embodiment that describes the submission of the account data through a submission form, the account data in the submission form would be provided after the closure of the reporting period. In the embodiment of that describes the submission of the account data through a point of sale terminal, the account data would be submitted following every transaction during the reporting period.

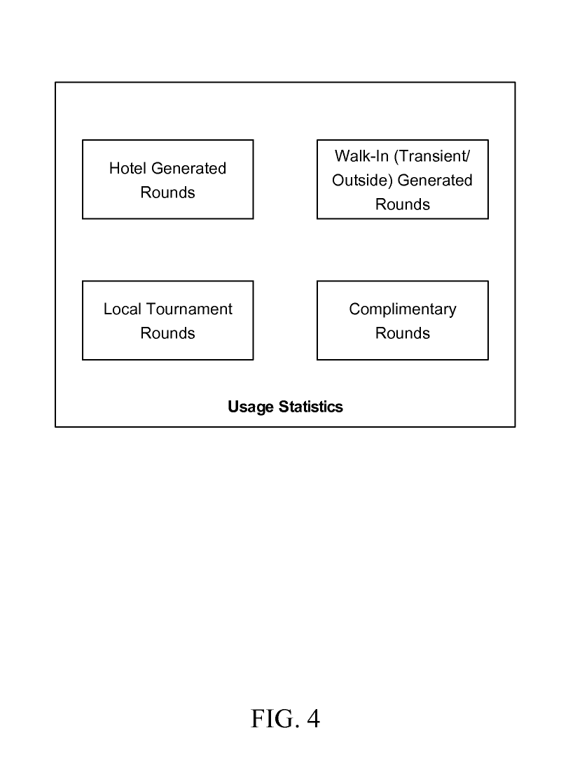

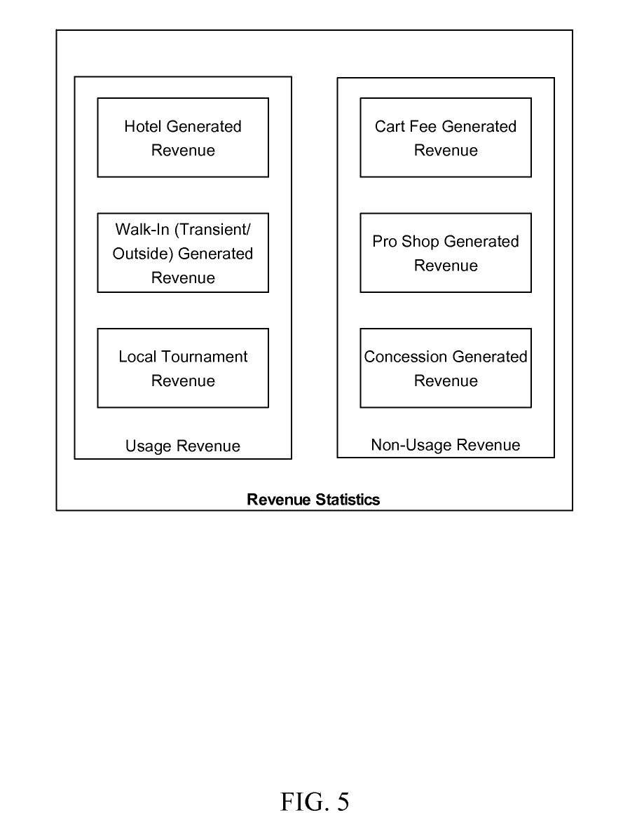

Referencing FIG. 4 and FIG. 5, the account data received associated with a particular user account comprises usage statistics and revenue statistics. Usage statistics are categorical values that describe the utilization of the golf course by particular groups of patrons. Revenue statistics are revenue values generated by the utilization of the golf course by particular groups of patrons and revenue values generated by secondary sources of revenue. In the current embodiment of the present invention usage statistics comprise the rounds of golf generated by hotels, walk-ins, and local tournaments, as well as, complimentary rounds accepted, during the particular reporting period. The hotel generated rounds are the rounds of golf played during the particular reporting period, purchased through partnerships with hotels. The walk-in, or transient/outside, generated rounds are rounds of golf played, during the particular reporting period, purchased by individuals with no affiliation or discounts. The local tournament generated rounds are the rounds of golf played during the particular reporting period, purchased as part of an organized local tournament. The complimentary rounds are the rounds of golf played during the particular reporting period, provided by the golf course through either promotions or as a courtesy.

Referencing FIG. 5, in the current embodiment of the present invention, revenue statistics comprise usage revenue and non-usage revenue generated during the particular reporting period. Usage revenue comprises golf course usage revenue generated by hotels, walk-ins, and local tournaments. Hotel generated revenue is the revenue generated by hotel generated rounds played during the particular reporting period. Walk-in, or transient/outside generated revenue is the revenue generated by walk-in, transient/outside, generated rounds played during the particular reporting period. Local tournament generated revenue is the revenue generated by local tournament generated rounds played during the particular reporting period. It should be noted that complimentary rounds are not included in the usage revenue, as they do not directly generate revenue. Furthermore, it should be noted that complimentary rounds are included in the account data as they can still generate secondary source revenue. Non-usage revenue comprises secondary source revenue generated by cart fees, pro shop sales, and concession sales. Secondary source revenue are ancillary expenses that an individual playing through a game of golf influences at their discretion. Cart fees generate revenue from the rental of golf carts for use during a round of golf. The pro-shop sales generate revenue through purchases at the pro shop throughout the course of a day. Concession sales generate revenue through purchases of food and beverage throughout the course of a day.

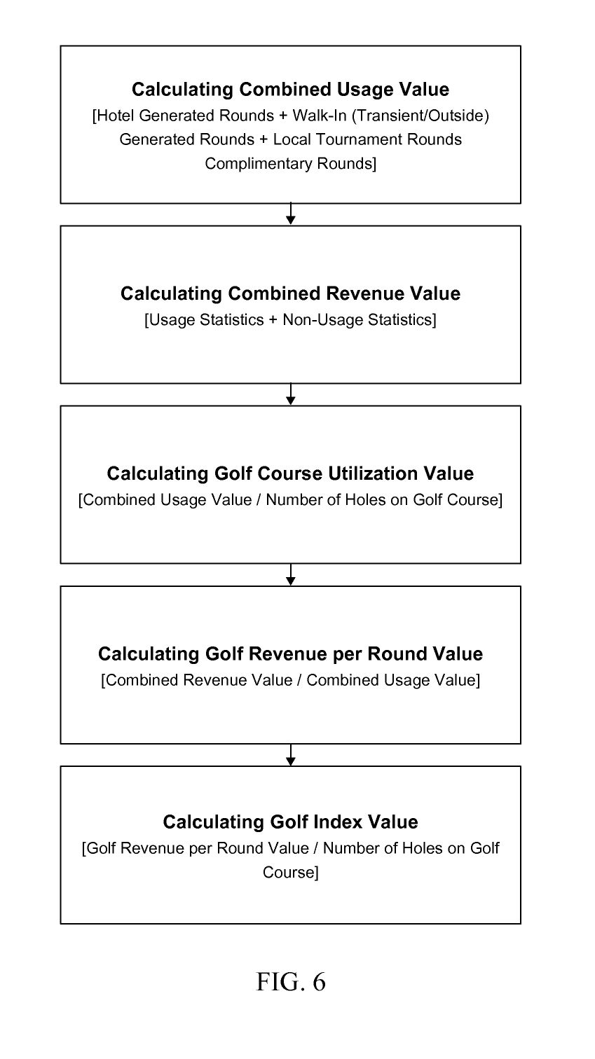

Referencing FIG. 6, the step of calculating account statistics for the plurality of user accounts is provided as a prerequisite step to generating competitive set statistics and an index report for the reporting period. The process of calculating account statistics for a particular user account utilizes the account data received for the particular reporting period as well as course data associated with the particular user account. specifically, the process uses the number of holes offered by the golf course associated with the user account. In the current embodiment of the present invention, the calculating account statistics for the particular reporting period comprises the steps of calculating a combined usage value, calculating a combined revenue value, calculating a golf course utilization value, calculating a golf revenue per round value, and calculating a golf index value.

Referencing FIG. 6, the combined usage value is the aggregate total of rounds played due to hotel generated rounds, walk-in, transient/outside generated rounds, local tournament generated rounds, and complimentary rounds accepted during the particular reporting period. The combined revenue value is the aggregate total for golf course usage revenue generated during the particular reporting period by hotels, walk-ins, and local tournaments and total secondary source revenue generated, during the particular reporting period, by cart fees, pro shop sales, and concession sales.

Referencing FIG. 6, the golf course utilization value is a usage score that is calculated by the dividing the combined usage value for the particular reporting period by number of holes offered by the golf course associated with said user account.

Referencing FIG. 6, the golf revenue per round value is the average revenue generated by each round of golf played during the particular reporting period. The golf revenue per round value is calculated by dividing the combined revenue value during the particular reporting period by the combined usage value during the particular reporting period.

Referencing FIG. 6, the golf index value is average revenue generated by usage of the golf course during the particular reporting period. The golf index value is calculated by dividing the golf revenue per round value for the particular reporting period by the golf course utilization value for the particular reporting period.

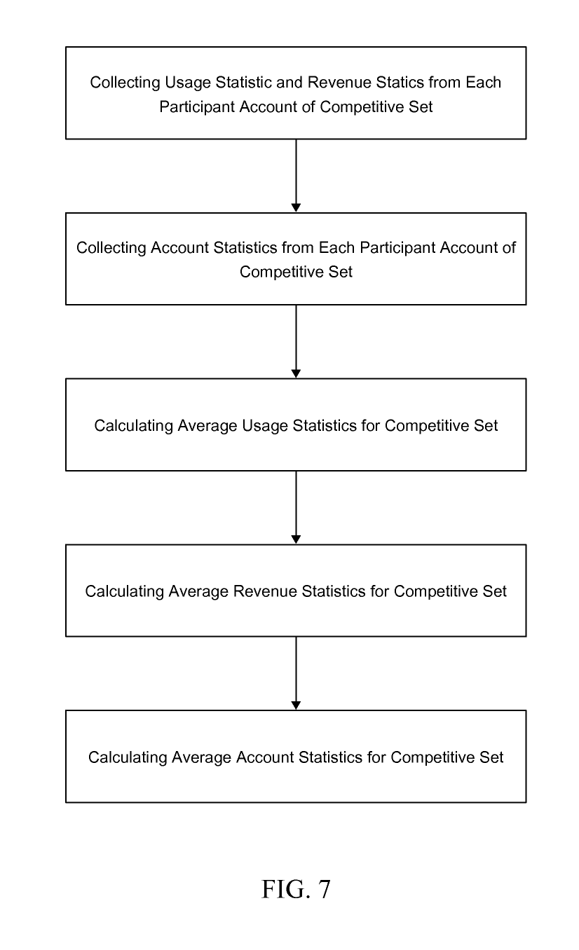

Referencing FIG. 7, the step of calculating the completive set statistics is provided as a perquisite step to generating an index report for a particular user account. The competitive set statistics are calculated for a competitive set during a particular reporting period. The competitive set, for which the competitive set statistics are being calculated for, comprise participant accounts that are user account from the user base that have agreed to participate in the competitive set. In the current embodiment of the present invention, the calculation of the competitive set statistics comprises the steps of collecting the usage statistic, the revenue statics, and account statistics from each participant account of the competitive set, calculating average usage statistics, calculating average revenue statistics, and calculating average account statistics for the competitive set.

the step of collecting the usage statistic, the revenue statics, and account statistics from each participant account of the competitive set is provided as a necessary step to the calculation of the competitive set statistics as the values from all participant accounts are necessary in to order to calculate the average values for the competitive set.

Referencing FIG. 7, the step of calculating average usage statistics for the competitive set using the collected usage statistics anonymizes the usage statistics for each participant account while providing a more representative usage value for the marketplace, during the particular reporting period. The average usage statistics are the mean values for the rounds of golf generated by hotels, walk-ins, and local tournaments as well as complimentary rounds accepted, during the particular reporting period, for the competitive set.

Referencing FIG. 7, the step of calculating average revenue statistics for the competitive set using the collected revenue statistics anonymizes the revenue statistics for each participant account while providing a more representative revenue value for the marketplace, during the particular reporting period. The average revenue statistics are mean values for the usage revenue values and the non-usage revenue values, during the particular reporting period, for the competitive set. Mean values are calculated for hotel generated revenue, walk-in, outside/transient generated revenue, and local tournament generated revenue of competitive set, as well as cart fee generated revenue, pro shop sale generated revenue, and concession sale generated revenue.

Referencing FIG. 7, the step of calculating average account statistics for the competitive set using the collected account statistics anonymizes the calculated account statistics for each participant account while providing a more representative calculated value for the marketplace, during the particular reporting period. The average account statistics are means values for the combined usage value, the combined revenue value, the golf course utilization value, the golf revenue per round value, and the golf index value, during the particular reporting period, for the competitive set

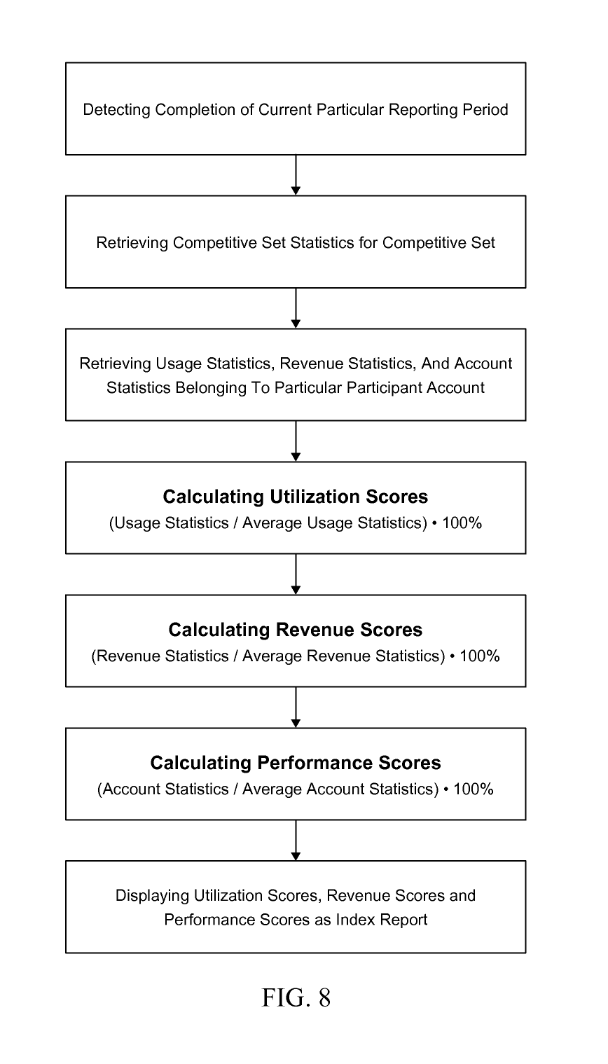

Referencing FIG. 8, the step of generating an index report is provided as the concluding step during a particular reporting period. An index report is generated for each participant account of a competitive set. Each index report is unique to the particular participant account as the values shown illustrate the particular participant accounts performance relative to the average performance of the competitive set. In the current embodiment of the present invention, the step of generating an index report comprises the steps detecting completion of a current particular reporting period, retrieving competitive set statistics for a competitive set, retrieving usage statistics, revenue statistics, and account statistics belonging to a particular participant account of the competitive set, calculating utilization scores, revenue scores, and performance scores for the particular participant account, and displaying the scores as the index report for the particular participant account.

Referencing FIG. 8, the step of detecting the completion of the current particular reporting period is provided as initiation step for generating an index report. An index report is specific to a reporting period and as such the values necessary for the calculation of the utilization score, revenue score, and performance score are not available until the particular reporting period closes. It should be noted that the detection step can be accomplished by any means of detecting an initiating event.

Referencing FIG. 8, the step of retrieving competitive set statistics for a competitive set and the step of retrieving usage statistics, revenue statistics, and account statistics belonging to a particular participant account of the competitive set, occur following the detection step. The aforementioned values are integral in the calculation of the utilization scores, revenue scores, and performance scores.

Referencing FIG. 8, the step of calculating the utilization scores generate percent comparison scores for the usage statistics of the particular participant account relative to average usage statistics of the competitive set for the particular reporting period. The utilization scores are calculated by comparing the usage statistics of the particular participant account to the average usage statistics of the competitive set and then multiplying by 100. The utilization scores display a percent value comparing the rounds of golf generated by hotels, walk-ins, and local tournaments, as well as, complimentary rounds accepted, for the particular participant account, against the average for the competitive set for the particular reporting period.

Referencing FIG. 8, the step of the calculating revenue scores generate percent comparison scores for the revenue statistics of the particular participant account relative to the average revenue statistics of the competitive set for the particular reporting period. The revenue scores are calculated by comparing the revenue statistics for the particular participant account to the average revenue statistics of the competitive set and then multiplying by 100. The revenue score displays a percent values for golf course usage revenue generated by hotels, walk-ins, and local tournaments and secondary source revenue generated by cart fees, pro shop sales, and concession sales, against the average for the competitive set for the particular reporting period.

Referencing FIG. 8, the step of calculating the performance scores generate percent comparison scores for the account statistic of the particular participant account relative to the average account statistics of the competitive set for the particular reporting period. The performance scores are calculated by comparing the account statistics for the particular participant account to the average account statistics for the competitive set and then multiplying by 100. The performance scores display percent values for the combined usage value, the combined revenue value, the golf course utilization value, the golf revenue per round value, and the golf index value against the average for the competitive set for the particular reporting period.

Upon completing the calculation steps, the utilization scores, revenue scores, and performance scores for the particular participant account are combined into the index report for the particular participant account. The index score displays the values graphically and may contain graphic representation of the scores relative to earlier reporting periods. The displayed index report is made available to the particular participant account through various means.

In an embodiment of the invention, the reporting period comprises a weekly and monthly interval. During the weekly intervals, account data is received on the Wednesday following the end of the reporting period. Account statistics and competitive set statistic are calculated upon availability and utilized to generate an index report by the Thursday following the end date for the particular reporting period. The index reports generated for a monthly interval can be calculated using the values found in index reports generated for a weekly interval but can also be sourced from a submitted account data specific to the monthly interval reporting period.

In an embodiment of the present invention, user submissions can occur throughout the course of the day through the use of an automatic transaction reporting process integrated into point of sale terminals of a user's golf course. The automatic transaction reporting process would be a networked connected system process which would relay transaction information to the golf index reporting system across a network connection. The automatic transaction reporting process identifies, extracts, and transmits individual transaction details to the user's account on the system. The transmission of the individual transaction details can occur following the completion of a transaction, or on a set schedule for transmission.

In an embodiment of the invention, the index reports comprise summary reports and detailed reports. Summary reports provide a general overview of a user's golf courses performance against their competitive set during a reporting period. The summary reports display the performance scores. Detailed reports display more specific comparative scores including those for values directly submitted as part of the user submission. The detailed reports display the utilization scores.

Although the invention has been explained in relation to its preferred embodiment, it is to be understood that many other possible modifications and variations can be made without departing from the spirit and scope of the invention as hereinafter claimed.

What is claimed is:

1. A method of generating golf index reports comprises the steps of:
providing a golf index reporting system comprising a user base, wherein the user base comprises a plurality of user accounts;
generating a new user account for inclusion into the user base;
creating a competitive set comprising user accounts from the user base and the new user account;
receiving account data from the plurality of user accounts for a particular reporting period, wherein account data comprises usage statistics and revenue statistics;
calculating account statistics for the plurality of user accounts for the particular reporting period;
calculating competitive set statistics for a competitive set using the usage statistics, the revenue statistics, and the account statistics from participant accounts;
generating an index report for a particular participant account by comparing the usage statistics, the revenue statistics, and the account statistics of said particular participant account to the competitive set statistics, wherein the index report corresponds to the particular reporting period;

2. The step of generating a new user account as claimed in claim 1 comprises the steps of:
receiving course data from a golf course comprising a golf course identifier and number of holes offered by said golf course;
creating a new user account in the user base using the course data, wherein the new user account is searchable through its golf course identifier;
prompting creation of a competitive set for the new user account;

3. The step of creating the competitive sets as claimed in claim 1 comprises the steps of:
receiving a plurality of requested golf course identifiers from a new user account, wherein a requested golf course identifier corresponds to a particular golf course;
transmitting participation requests to particular golf courses associated with the requested golf course identifiers;
receiving responses for the participation requests from the particular golf courses;
generating a competitive set with the user accounts accepting the participation request and the new user account;

4. The step of creating a competitive set as claimed in claim 3 comprises the steps of:
comparing the plurality of requested golf course identifier to the golf course identifiers of the plurality of user accounts in the user base;
transmitting a participation request to a golf course associated with a user account within the user base,
if the golf course identifier of a user account in the user base matches the requested golf course identifier;
determining communication means for contacting a particular golf course associated with a particular requested golf course identifier,
transmitting a system invitation and a participation request to the particular golf course associated with the particular requested golf course identifier through the determined communications means,
if a golf course identifier of the plurality of user accounts in the user base does not match the particular requested golf course identifier;

5. The step of receiving account data as claimed in claim 1 comprises the steps of:
receiving usage statistic associated with a particular user account for a particular reporting period, wherein the usage statistics comprise the rounds of golf generated by hotels, walk-ins, and local tournaments, as well as, complimentary rounds accepted, during the particular reporting period;
receiving revenue statistics associated with the particular user account for the particular reporting period, wherein the revenue statistics comprise usage revenue and non-usage revenue generated, during the particular reporting period;
wherein usage revenue comprises golf course usage revenue generated by hotels, walk-ins, and local tournaments;
wherein non-usage revenue comprises secondary source revenue generated by cart fees, pro shop sales, and concession sales;

6. The step calculating the account statistics as claimed in claim 1 comprises the steps of:
calculating a combined usage value for a user account by aggregating total rounds of golf generated by hotels, walk-ins, and local tournaments, as well as, complimentary rounds accepted, during the particular reporting period;
calculating a combined revenue value for the user account by aggregating total golf course usage revenue generated during the particular reporting period by hotels, walk-ins, and local tournaments and total secondary source revenue generated, during the particular reporting period, by cart fees, pro shop sales, and concession sales;
calculating a golf course utilization value for the user account by dividing the combined usage value for the particular reporting period by number of holes offered by the golf course associated with said user account;
calculating a golf revenue per round value for the user account by dividing the combined revenue value during the particular reporting period by the combined usage value during the particular reporting period;
calculating a golf index value for the user account by dividing the golf revenue per round value for the particular reporting period by the golf course utilization value for the particular reporting period;

7. The step of calculating the competitive set statistics as claimed in claim 1 comprises the steps of:
providing the competitive set comprising participant accounts, wherein the participant accounts of the competitive set are user accounts from the user base;
providing usage statistics comprising the rounds of golf generated by hotels, walk-ins, and local tournaments, as well as, complimentary rounds accepted, during the particular reporting period;
providing revenue statistics comprising usage revenue values and non-usage revenue values, wherein usage revenue values comprise golf course usage revenue generated by hotels, walk-ins, and local tournaments, and non-usage revenue values comprise secondary source revenue generated by cart fees, pro shop sales, and concession sales, during the particular reporting period;
providing account statistics comprising a combined usage value, a combined revenue value, a golf course utilization value, a golf revenue per round value, and a golf index value;
collecting the usage statistic and the revenue statics, for the particular reporting period, from each participant accounts of the competitive set,
collecting the account statistics, for the particular reporting period, from each participant account of the competitive set;
calculating average usage statistics for the competitive set using the collected usage statistics, wherein the average usage statistics are the mean values for the rounds of golf generated by hotels, walk-ins, and local tournaments as well as complimentary rounds accepted, during the particular reporting period, for the competitive set;
calculating average revenue statistics for the competitive set using the collected revenue statistics, wherein the average revenue statistics are mean values for the usage revenue values and the non-usage revenue values, during the particular reporting period, for the competitive set;
calculating average account statistics for the competitive set using the collected account statistics, wherein the average account statistics are means values for the combined usage value, the combined revenue value, the golf course utilization value, the golf revenue per round value, and the golf index value, during the particular reporting period, for the competitive set;

8. The step of generating an index report as claimed in claim 1 comprises the steps of:
providing the competitive set comprising a plurality of participant accounts, wherein the plurality of participant accounts contains a particular participant account;
providing the particular participant account comprising usage statistics, revenue statistics, and account statistics for the particular reporting period;
providing the competitive set statistics comprising average usage statistics, average revenue statistics, and average account statistics for the particular reporting period;
detecting completion of a current particular reporting period;
retrieving competitive set statistics for a competitive set, for the particular reporting period;
retrieving usage statistics, revenue statistics, and account statistics belonging to a particular participant account of the competitive set, for the particular reporting period;
calculating utilization scores by comparing the usage statistics of the particular participant account to the average usage statistics of the competitive set;
calculating revenue scores by comparing the revenue statistics of the particular participant account to the average revenue statistics of the competitive set;
calculating performance scores by comparing the account statistics of the particular participant account to the average account statistics of the competitive set;
displaying the utilization scores, the revenue scores and the performance scores as the index report, during the particular reporting period, for the particular participant account; [symbol]
